(19) United States
(12) Patent Application Publication
(10) Pub. No.: US 2004/0165491 A1
(43) Pub. Date: Aug. 26, 2004

(54) Optical drive tracking control method

(76) Inventor: Chian-Shiung Wang, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/447,832

(22) Filed: May 29, 2003

(30) Foreign Application Priority Data
Feb. 24, 2003 (TW) 092103825

(51) Int. Cl. G11B 7/095

(52) U.S. Cl. 369/44.26; 369/44.37; 369/44.29

(57) ABSTRACT

An optical drive tracking control method allowing an optical drive to select a first tracking error detecting method or a second tracking error detecting method to generate tracking error signals when reading a CD is provided. First of all, a CD is read and the first tracking error detecting method is used to generate a first tracking error signal. Next, determine if the first tracking error signal is correct or not: if yes, continue to use the first tracking error detecting method, otherwise, change to the second tracking error detecting method. Of which, the first tracking error detecting method can be the three-beam method or the differential push pull method (DPP method), while the second tracking error detecting method can be the differential phase detection method (DPD method).

This application claims the benefit of Taiwan application Serial No. 92103825, filed Feb. 24, 2003.

### BACKGROUND OF THE INVENTION

1. Field of the Invention

The invention relates in general to an optical drive tracking control method, and more particularly to an optical drive tracking control method using the three-beam method, the differential push pull method (DPP method) or the differential phase detection method (DPD method) to generate tracking error signals.

2. Description of the Related Art

Living in today's society where science and technology advance rapidly and the application of pictures, music and computer software have won great popularity, the compact disc (CD) having high storage capacity has become an essential software carriage to modern people. Owing to the advantageous features of high storage capacity, compactness and security of data storage, the CD has won great popularity. Moreover, the CD-ROM optical drive which is used to read the CD has therefore become an essential apparatus of a personal computer (PC).

Please refer to FIG. 1, a flowchart illustrating the conventional CD reading process of a CD-ROM optical drive. The process starts with step 102: a CD is loaded into a CD-ROM optical drive and is driven to rotate itself. Next, proceed to step 104: move the optical pick-up head of the CD-ROM optical drive and place it besides the CD which is rotating. After that, proceed to step 106: finely adjust the focus servo system of the CD-ROM optical drive for focusing purpose. Lastly, proceed to step 108: finely adjust the tracking servo system of the CD-ROM optical drive and use the three-beam method or the differential push pull method (DPP method) to generate tracking error signals. The tracking of the optical drive can be determined according to the generated tracking error signals. Once the tracking is assured, the CD-ROM optical drive will be able to read the data stored in the CD. This method ends here.

Generally speaking, there exists a corresponding relationship between the wavelength of laser light of the CD-ROM optical drive and the size of standard CD track pitches. In terms of standard specification, the laser light generated by CD-ROM optical drive has a wave length of 780 nanometer (nm) while the standard size of CD track pitch is 1.6 micrometer (μm) allowing light spots to fall on the track pitches.

In order to increase the storage capacity, some manufacturers particularly design a CD whose track pitch is smaller than standard specification or even modify the pit depth of the CD. As a result, when reading CDs of various specifications, the CD-ROM optical drive fails to detect the CD-reflected signals of the spots. Meanwhile, the tracking error signals generated by the three-beam method or by the DPP method will reflect incorrect tracking status. If the CD-ROM optical drive continues to use the three-beam method or the DPP method to generate tracking error signals, the CD-ROM optical drive will end up with a poor tracking effect and a slow read speed. Since the CDs currently available in the market are actually of uneven quality levels, the CD-ROM optical drive which can only use the three-beam method or the DPP method to generate tracking error signals will turn out to be inadequate.

### SUMMARY OF THE INVENTION

It is therefore an object of the invention to provide an optical drive tracking control method allowing an optical drive to select the three-beam method, the differential push pull method (DPP method) or the differential phase detection method (DPD method) to generate tracking error signals to assure CD tracking and increase read speed when reading a CD.

It is therefore an object of the invention to provide an optical drive tracking control method allowing an optical drive to select the three-beam method or the DPD method to generate tracking error signals when reading a CD. According to this method, first of all, a CD is read and the three-beam method is used to generate a first tracking error signal. Next, determine if the first tracking error signal is correct or not. If the first tracking error signal is correct, continue to use the three-beam method, otherwise, change to the DPD method.

It is therefore an object of the invention to provide an optical drive tracking control method allowing an optical drive to select DPP method or the DPD method to generate tracking error signals when reading a CD. According to this method, first of all, a CD is read and the DPP method is used to generate a first tracking error signal. Next, determine if the first tracking error signal is correct or not. If the first tracking error signal is correct, continue to use the DPP method, otherwise, change to the DPD method.

It is therefore an object of the invention to provide an optical drive tracking control method allowing an optical drive to select a first tracking error detecting method or a second tracking error detecting method to generate tracking error signals when reading a CD. According to this method, first of all, a CD is read and the first tracking error detecting method is used to generate a first tracking error signal. Next, determine if the first tracking error signal is correct or not. If the first tracking error signal is correct, continue to use the first tracking error detecting method, otherwise, change to the second tracking error detecting method. Of which, the first tracking error detecting method can be the three-beam method or the DPP method, while the second tracking error detecting method can be the DPD method.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a flowchart illustrating the conventional CD reading process of a CD-ROM optical drive;

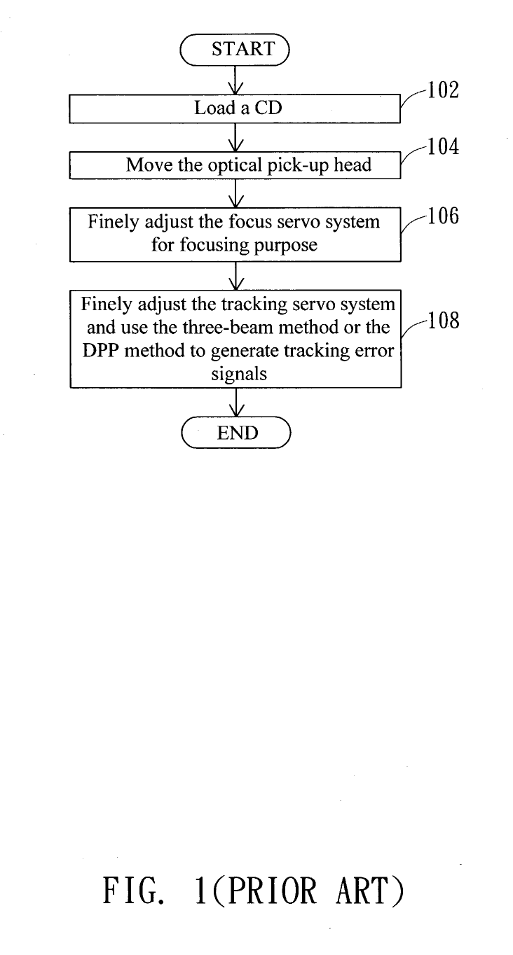

FIG. 2 is a flowchart for the optical drive tracking error detecting method according to a preferred embodiment of the invention; and

FIG. 3 is a schematic diagram for the photodetector and two sub-photodetectors of an optical pick-up head.

### DETAILED DESCRIPTION OF THE INVENTION

The present invention particularly designs an optical drive tracking control method allowing an optical drive to select the three-beam method, the differential push pull method (DPP method) or the differential phase detection method (DPD method) to generate tracking error signals to assure the tracking effect and increase the read speed of the optical drive.

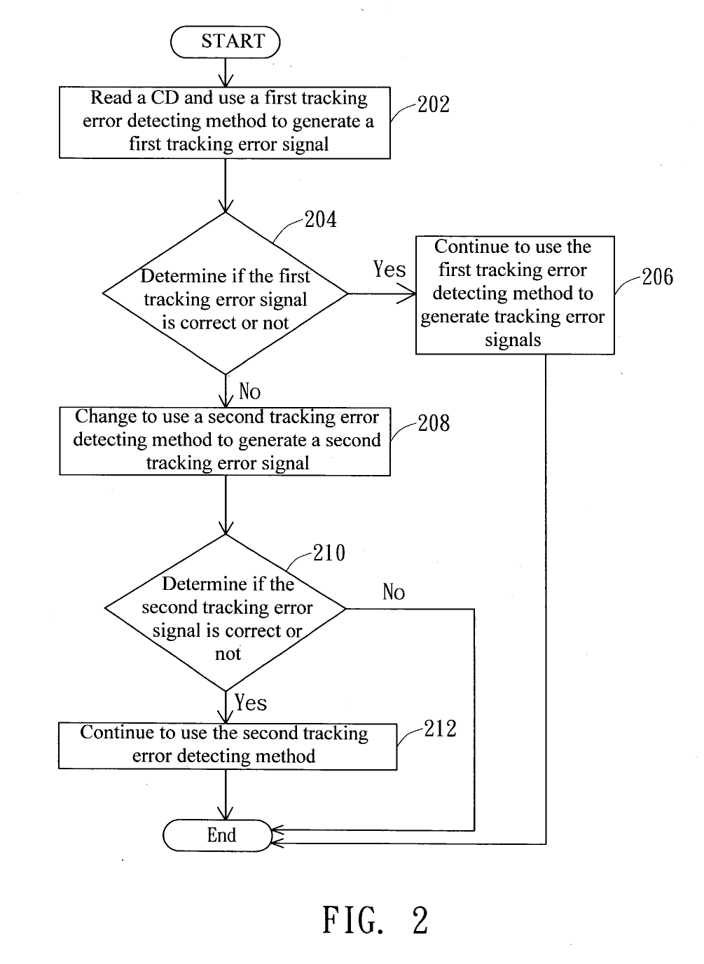

Please refer to FIG. 2, a flowchart for the optical drive tracking error detecting method according to a preferred embodiment of the invention. In FIG. 2, first of all, step 202 is performed: an optical drive is used to read a CD, meanwhile, the first tracking error detecting method is used to generate a first tracking error signal. Of which, the optical drive can be a CD-ROM optical drive, and this method can use the three-beam method or the DPP method as the first tracking error detecting method.

When the three-beam method is used to generate the first tracking error signal, the laser light generated by the pick-up head of the optical drive will form three light beams: the main beam and the two sub beams which are symmetrically situated at the two sides of the main beam. The three beams shed light on the CD and correspondingly form a main spot and two sub spots thereon. The optical pick-up head receives the CD-reflected light generated by the two sub beams and generates corresponding tracking error signals accordingly. Therefore the tracking error signals generated by the three beams are directly related to the locations of the two sub spots on the CD.

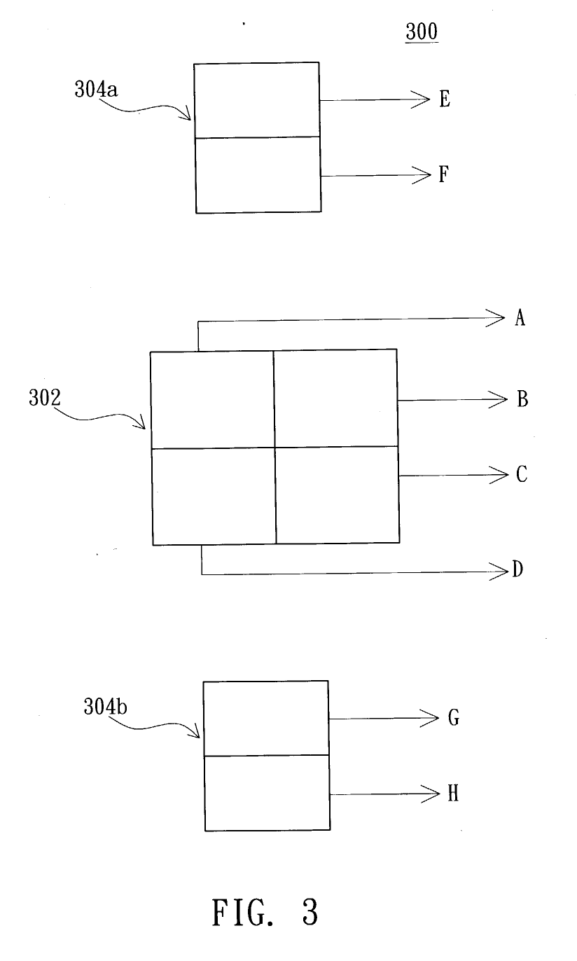

Besides, the optical pick-up head includes at least photodetector 302 and two sub-photodetectors 304a and 304b as shown in FIG. 3. In FIG. 3, photodetector 302 is used to receive the CD-reflected light generated by the main beam and output four detected signals represented by A, B, C, and D respectively. Sub-photodetector 304a is used to receive the CD-reflected light generated by a sub beam and output two detected signals represented by E and F respectively; sub-photodetector 304b is used to receive another CD-reflected light generated by another sub beam and output two detected signals represented by G and H respectively. According to the three-beam method, detected signals E, F, G, and H will be processed and form a first tracking error signal which can be written as ((E+F)−(G+H)) for instance after operations of relevant adders and subtractors.

When the DPP method is used to generate the first tracking error signal, detected signals A, B, C, D, E, F, G, and H will be processed and form a first tracking error signal which can be written as {((A+D)−(B+C))+K((E−F)+(H−G))} for instance after relevant adders and subtractors are operated. Of which, K is a constant used to equalize the amplitudes of ((A +D)−(B+C)) and ((E−F)+(H−G)) .

Next, proceed to step 204 to determine if the first tracking error signal is correct or not. If it is correct, proceed to step 206 and continue to use the first tracking error detecting method to generate tracking error signals. This method ends here. If the first tracking error signal is incorrect, proceed to step 208 to change to the second tracking error detecting method and read the CD again to generate a second tracking error signal. Of which, this method can use the DPD method as the second tracking error detecting method. This method can be concluded after the second tracking error detecting method is selected.

The DPD method is normally used as the tracking error signal generating method for the digital video disc (DVD) optical drive. It is noteworthy that the method according to the invention applies the DPD method to the CD-ROM optical drive using relevant equalizers, phase comparators, and low-pass filters to process detected signals A, B, C and D such that these signals will form a second tracking error signal which can be written as (P(A+C)−P(B+D)) wherein P (A+C) and P (B+D) are pulse train and P is phase. Therefore the generating of the second tracking error signal is only relevant to the main spot location on the CD formed by the main beam and to the intensity of the CD-reflected light generated by the main beam and is totally irrelevant to the two sub beams.

After that, proceed to step 210 to determine if the second tracking error signal is correct or not. If the second tracking error signal is correct, proceed to step 212 and continue to use the second tracking error detecting method to generate tracking error signals and this method ends here. If the second tracking error signal is incorrect, end this method directly.

Using the DPD method to generate tracking error signals has its advantages. That is, despite that the track pitch of the CD is smaller than 1.6 μm, the standard specification, or that the pit depth of the CD has been modified, the CD still can be tracked using the tracking error signals generated by the DPD method, provided that the main beam can shed on the track and that the differential phases of signals A, B, C and D can be detected. Facing CDs of uneven quality levels, this method, after determining the CD specification, will select proper tracking error signal generating method for CD tracking so as to read the stored data and increase the read speed of the optical drive.

The optical drive tracking control method disclosed in the above embodiment can be applied to an optical drive to select the three-beam method, the DPP method or the DPD method to generate tracking error signals when reading a CD so as to assure CD tracking and increase the read speed of the optical drive.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An optical drive tracking control method for an optical drive to read a compact disc (CD) wherein this method comprises the steps of:
reading the CD and using a three-beam method to generate a first tracking error signal;
determining if the first tracking error signal is correct or not; and
continuing to use the three-beam method if the first tracking error signal is correct, and changing to use a differential phase detection method (DPD method) if the first tracking error signal is incorrect.

2. The method according to claim 1, wherein the method further comprises the following steps after changing to a DPD method:
reading the CD and using the DPD method to generate a second tracking error signal;
determining if the second tracking error signal is correct or not; and
continuing to use the DPD method if the second tracking error signal is correct, and concluding this method if the second tracking error signal is incorrect.

3. The method according to claim 1, wherein the optical drive is a CD-ROM optical drive.

4. An optical drive tracking control method used for an optical drive to read a compact disc (CD), wherein this method comprises the steps of:
reading the CD and using a differential push pull method (DPP method) to generate a first tracking error signal;
determining if the first tracking error signal is correct or not; and
continuing to use the DPP method if the first tracking error signal is correct, and changing to use a DPD method if the first tracking error signal is incorrect.

5. The method according to claim 4, wherein the method further comprises the following steps after changing to a DPD method:
reading the CD and using the DPD method to generate a second tracking error signal;
determining if the second tracking error signal is correct or not; and
continuing to use the DPD method if the second tracking error signal is correct, and concluding this method if the second tracking error signal is incorrect.

6. The method according to claim 4 wherein the optical drive is a CD-ROM optical drive.

7. An optical drive tracking control method used for an optical drive to read a compact disc (CD) wherein this method comprises the steps of:
reading the CD and using a first tracking error detecting method to generate a first tracking error signal;
determining if the first tracking error signal is correct or not; and
continuing to use the first tracking error detecting method if the first tracking error signal is correct, and changing to use a second tracking error detecting method if the first tracking error signal is incorrect.

8. The method according to claim 7, wherein the method further comprises the following steps after changing to a second tracking error detecting method:
reading the CD and using the second tracking error detecting method to generate a second tracking error signal;
determining if the second tracking error signal is correct or not; and
continuing to use the second tracking error detecting method if the second tracking error signal is correct, and concluding this method if the second tracking signal is incorrect.

9. The method according to claim 7, wherein the first tracking error detecting method is a three-beam method.

10. The method according to claim 7, wherein the first tracking error detecting method is a DPP method.

11. The method according to claim 7, wherein the second tracking error detecting method is a DPD method.

12. The method according to claim 7, wherein the optical drive is a CD-ROM optical drive.
